(19) United States
(12) Patent Application Publication
(10) Pub. No.: US 2010/0049670 A1
(43) Pub. Date: Feb. 25, 2010

(54) Method and Media for Communicating Relevance of a Diaper Product to Targeted Consumers

(76) Inventors: Fama Francisco, Cincinnati, OH (US); Thomas Henrich, Montgomery, OH (US); Kristin Herrmann-Ratz, Cincinnati, OH (US); Monica Jean Mohlenkamp, Cincinnati, OH (US); Mark Andrew Thornton, Oberursel (DE); Sue Ann Mills, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/546,233

(22) Filed: Aug. 24, 2009

Related U.S. Application Data
(60) Provisional application No. 61/091,103, filed on Aug. 22, 2008.

(51) Int. Cl. G06Q 90/00

(52) U.S. Cl. 705/500

(57) ABSTRACT

Methods for communicating the relevance and benefits of a diaper product comprising a wearable structure and a replaceable component, to members of a market segment. Particular examples comprise the steps of: providing a tangible medium containing visual content comprising one or more photographic images of an adult, a child and a diaper product in at least partial view, and, either, the adult appearing to be engaged in the act of changing the replaceable component while the child is wearing the wearable structure, or, the diaper appearing to include a wearable structure and a removable or replaceable component; and causing the visual content to be made available for viewing by members of the public.

### CROSS REFERENCE TO RELATED APPLICATION

This application claims the benefit of U.S. Provisional Application No. 61/091,103, filed Aug. 22, 2008, the substance of which is incorporated herein by reference.

### BACKGROUND OF THE INVENTION

Consumer behavior is a complex subject. Although it has been studied extensively within the realm of marketing science, much remains to be understood. The complexity and variety of things such as human perceptions, experiences, pre-existing knowledge, opinions and attitudes, cultural influences, social influences, demographics, emotions, motivations and reasoning processes in commercial settings often defy attempts to develop general rules or models that are consistently predictive of the perception, behavior or response of a consumer market segment in any particular set of circumstances.

For this reason, when producers of consumer products contemplate a new product launch, they often engage in extensive specific consumer research in an attempt to identify elements of an advertising theme, message, and specific embodiment and execution thereof that will be most effective in stimulating consumer interest, and most importantly, initial purchase intent. Even when a product has demonstrable relevance, benefits and value for a segment of the consumer market, the nature and content of a message that will effectively motivate the consumer are rarely readily apparent or easily discovered. Similarly, conceptualization and design of materials that will effectively convey that message are not often easily accomplished. To make the task more difficult, the message may be effective but the materials may be ineffective, or vice versa, and the component in which the weakness exists may not be apparent.

Sometimes complicating the situation further is the condition, presented in many instances, in which relevant consumers may have, or only be willing to devote, limited attention and time to receiving and processing material presented. Without intending to be bound by theory, it is believed generally that consumers will devote comparatively less attention and time to receiving and processing advertising material relating to relatively low-risk (e.g., routine and relatively inexpensive) purchases, as compared with advertising material relating to relatively high-risk (e.g., relatively expensive) purchases. Thus, the additional challenge of designing an advertising message, theme, embodiment and execution that will be both rapidly perceived and processed, as well as effective at reaching the target market segment and stimulating interest, may be presented when a relatively inexpensive product involving a routine purchase is involved.

Persons experienced in the field recognize that even with substantial investments in expertise, effort and pre-testing, many marketing/advertising executions prove ineffective, for reasons often only appreciated in hindsight.

In the instant situation, a diaper product having certain features and creating the potential for demonstrable benefits for a segment of the consumer market—parents and other caregivers of young children who wear diapers—has been identified for potential launch in the market. The diaper product includes a wearable diaper structure, combined with a replaceable absorbent component. The diaper product enables a partial “change” when appropriate, i.e., when the absorbent component contains urine, by replacement of the absorbent component without removal of the wearable structure from the child. The product has several features providing potential advantages for caregivers over other types of diapers. These features include compactness of a replaceable absorbent component as compared with a conventional single-piece disposable diaper; features enabling a change of replaceable absorbent component that is generally substantially faster than a change of a conventional single-piece disposable diaper; and features enabling a change of the replaceable absorbent component while the wearable structure is being worn by the child, even when the child is wearing an outer garment over the wearable structure. These features potentially provide various advantages for the consumer.

Therefore, a need exists for a medium with a combination of elements that will rapidly and effectively communicate to consumers in the relevant market segment the relevance and advantages of the particular diaper product identified (or diaper products having similar features and advantages) for them, so as to better stimulate interest and initial purchase intent.

### SUMMARY OF THE INVENTION

Methods for communicating the relevance and benefits of a diaper product to members of a market segment are provided.

One particular example comprises the steps of: providing a tangible medium containing visual content, comprising one or more photographic images depicting an adult, and a child wearing a diaper product, with the diaper product in at least partial view, and the adult appearing to be engaged in the act of changing a replaceable component of the diaper product while the child is wearing it; and causing the visual content to be made available for viewing by members of the public.

Another particular example comprises the steps of: providing a store display containing visual content, comprising one or more photographic images of an adult, and a child wearing a diaper product, with the diaper product in at least partial view, and the adult appearing to be engaged in the act of changing a replaceable component of the diaper product while the child is wearing it; and causing the store display to be placed in a retail store in a location proximate to a place where the diaper product is shelved or displayed, wherein the diaper product comprises in combination a wearable structure and a replaceable absorbent component, the wearable structure and the replaceable absorbent component being packaged and shelved together or separately.

Still another particular example comprises the steps of: providing a tangible medium containing visual content, comprising one or more photographic images of an adult, a child and a diaper product in at least partial view, wherein the diaper product appears to include a wearable structure and a removable or replaceable component, at least one of the photographic images containing a visual situational cue suggesting that one or both of the adult and child are in a situational setting in which a diaper change would be inconvenient, difficult, disruptive, delaying, time-consuming, unsanitary, embarrassing, indiscrete, interruptive, offensive or inappropriate; and causing the visual content to be made available for viewing by members of the public.

### BRIEF DESCRIPTION OF THE DRAWINGS

FIG. 1 depicts a photographic image illustrating features of a photographic image embodying several examples of elements of interest-generating content as described herein;

FIG. 2 depicts a photographic image illustrating features of a photographic image embodying several examples of elements of interest-generating content as described herein;

FIG. 3 depicts a photographic image illustrating features of a videographic presentation embodying several examples of elements of interest-generating content as described herein;

FIG. 4 depicts a photographic image illustrating features of a videographic presentation embodying several examples of elements of interest-generating content as described herein;

FIG. 5 depicts a photographic image illustrating features of a photographic image embodying several examples of elements of interest-generating content as described herein;

FIG. 6 depicts a photographic image illustrating features of a photographic image embodying several examples of elements of interest-generating content as described herein;

FIG. 7 depicts a photographic image illustrating features of a diaper product package embodying several examples of elements of interest-generating content as described herein; and

FIGS. 8A to 8C are examples of composite artwork illustrating features of composites of photographic imagery and commercial art embodying several examples of elements of interest-generating content as described herein, for use on diaper product packages or other store display items.

The photographic images in the Figures have had certain details, not necessary to the instant disclosure, blurred or obscured.

### DETAILED DESCRIPTION OF THE INVENTION

### Definitions

For purposes of this description, the following terms have the meanings set forth:

“Diaper product” means a diaper or pant-type article designed to be worn by a child who is not yet completely toilet trained, and components of the article effective to absorb a quantity of urine discharged therein by the wearer. “Diaper product” includes a diaper or pant product having a wearable structure and a replaceable absorbent component such as, for example, those described in U.S. Pat. Nos. 6,015,935, 6,989,005, 6,989,006, 6,932,800, 7,291,137, and 7,381,202, and U.S. applications Ser. Nos. 09/431,322, 11/430,367, 10/410,783, 10/308,430, 11/430,367, 11/430,388, 11/430,744, 11/430,569, 11/445,624, 11/446,460, 11/430,746, 11/636,675, and 11/978,051 the descriptive matter in which is incorporated herein by reference.

“Store display item” includes any and all items that a producer or seller of a product may cause to be placed on display in a retail store, that include visually and/or verbally descriptive or promotional content relating to the particular product or group of related products. “Store display item” includes, but is not limited to, product packaging, shelf displays or “shelf talkers,” brochures, booklets, leaflets, fliers, postcards, specially adapted boxes, bins, cartons, racks, shelving, showcases, tables, kiosks, counters, stands and the like, signs, posters and banners, including electronic versions of the same, placed or displayed in proximity to the product in the store.

“Videographic medium” means any tangible medium upon which a recording of moving and/or changing visual content can be stored, and from which the recording can be played, using playback equipment. “Videographic medium” includes but is not limited to analog or digital videotape, other magnetic tape on which visual content may be stored, optical disc, hard drive, flash memory device, web server, and any other device upon which a recording of moving and/or changing visual content can be stored, and from which the recording can be played, using playback equipment (including computers and related equipment).

“Proximate to” (and forms thereof), when used to characterize the location of a second object with respect to the location of a first object, means any location of the second object whereby a human viewer may view both objects by moving the eyes or head, or by turning about, bending, stretching or kneeling, from a single vantage point, but without moving the body substantially away from the vantage point. A second object will be “proximate to” a first object if a viewer can see both objects from any single vantage point.

### The Tangible Medium

The invention includes a tangible medium, having the additional elements set forth in one or more of the appended claims, examples of which elements are further described under “Interest-Generating Content” below, and the use thereof.

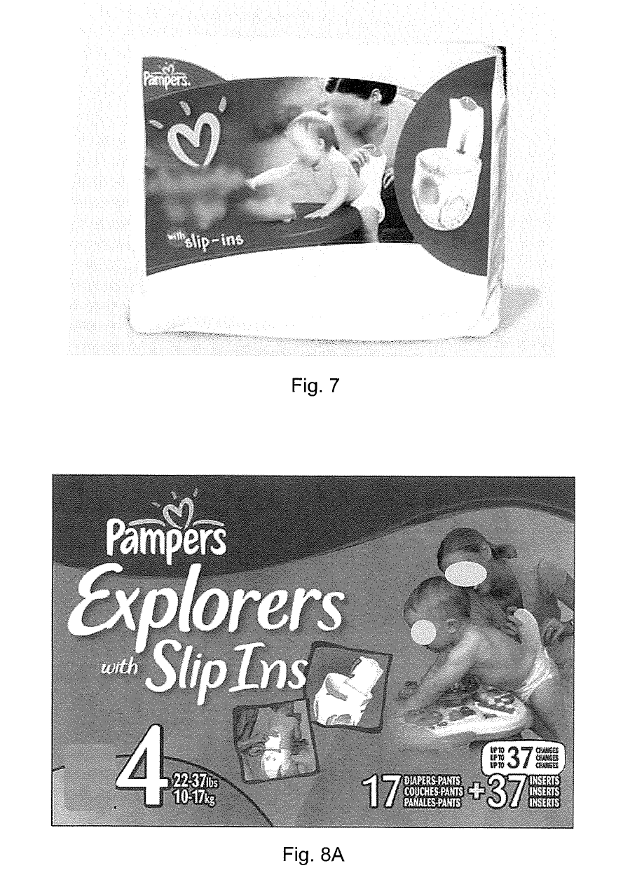

The tangible medium may be, for example, a store display including one or more store display items. In one example, the store display may be or include packaging for the diaper product itself (see, e.g., FIG. 7). The store display also may be or include a combination of separate packages of two or more units of diaper product, where the combination of such store display items has the additional elements set forth in one or more of the appended claims, examples of which elements are described under “Interest-Generating Content” below. For example, a first package may enclose one or more wearable structures, and a second package may enclose a supply of replaceable absorbent components. In another example, a first package may enclose one or more wearable structures together with a supply of replaceable absorbent components, and a second package may be similar in that regard, but have differing visual content, the combination having additional elements as set forth in the appended claims, examples of which elements are described under “Interest-Generating Content” below. In other examples, the store display may include shelf displays or “shelf talkers,” brochures, booklets, leaflets, fliers, postcards, specially adapted boxes, bins, cartons, racks, shelving, showcases, tables, kiosks, counters, stands and the like, signs, posters and banners (including electronic media), placed or displayed in proximity to the product in the store. Any store display item alone, or in combination with one or more other store display items, will have additional elements as set forth in one or more of the appended claims, examples of which elements are described under “Interest-Generating Content” below.

The tangible medium may also be another form of printed medium, such as a magazine or newspaper, or a page thereof, or a brochure, booklet, leaflet, flier, postcard, sign, poster or banner. In another example, the tangible medium may be an advertising poster, sign or billboard, including electronic versions thereof. The tangible medium also may take the form of an electronic storage medium (such as a flash memory device, hard drive, etc.) containing stored visual content, together with equipment that reads from the electronic storage medium and makes the visual content available for viewing by humans. Thus, the tangible medium may include computer and related equipment used to store visual content and deliver it, for example, by electronic mail.

In another example, the tangible medium may be a videographic medium. The visual content stored thereon, alone or in combination with other media, will have additional elements set forth in one or more of the appended claims, examples of which elements are described under “Interest-Generating Content” below. The videographic medium will be adapted such that it may be used in conjunction with suitable playback equipment, so that the visual content may be played and viewed. As noted above, suitable playback equipment may include computer and related equipment that may be used to read from a videographic medium and produce the videographic content, such as, for example, via a web site available to Internet users.

### Interest-Generating Content

It has been discovered that content including one or more combinations of certain visual elements set forth in one or more of the appended claims, examples of which elements are described further herein, is more effective at stimulating interest and initial purchase intent than other content not having such a combination of visual elements. Generally, the relevant consumer market segment is deemed to be, primarily, parents of young children still wearing diapers.

As exemplified by the Figures, the visual content may include photographic or videographic images of one or more actual human subjects, objects and settings. Thus, it may be contained in one or more photographs or videos depicting apparent actual persons, places and objects, as distinguished from, e.g., drawings, paintings, cartoons, animations or other artists' renderings. Without intending to be bound by theory, it is believed that use of such photographic or videographic images in these circumstances is more effective for rapid conveyance and processing of information than other forms of communication such as oral or written verbal communication and/or artist's renderings, because of several factors. Without intending to be bound by theory, it is believed that the realistic appearance of photographic or videographic images of appropriate subject matter generally is perceived by the consumer as more credible and concrete as a depiction of a real-life situation likely to be experienced by the consumer. Without intending to be bound by theory, it believed further that the information contained and conveyed in photographic images is much more abundant and detailed, but at the same time much more quickly processed by the consumer. It is believed that this is because fewer intervening mental steps are required to process and understand the information, e.g., reading, interpreting, categorizing and mentally placing in context information that is presented in more abstract form, are required.

Without intending to be bound by theory, and following the discovery thereof, it is believed that a message to the effect that the parent or caregiver can replace the replaceable absorbent component while the child is otherwise engaged in exploration or play (effecting a “change” of sorts of a soiled diaper), without substantially interrupting the child's activity, is a message that resonates in the market segment. Thus, without intending to be bound by theory, and following the discovery thereof, it is believed that visual content realistically depicting a child apparently wearing the diaper product and engaged in play or exploration, and apparently having a change of the replaceable absorbent component performed without any apparent substantial distraction or interruption, enable a parent to quickly imagine and appreciate the advantages this affords, for example, speed and ease of the change, fewer or no struggles with a child who is uncooperative or does not want to be changed or interrupted, and not interrupting the child's play or exploration. Thus, one or more of the combinations set forth in the appended claims are believed more effective at stimulating interest in the diaper product, and motivating initial purchase, in comparison with other possible approaches.

Without intending to be bound by theory, and following the discovery thereof, it is believed additionally that a message to the effect that the product is for the “on-the-go”, busy parent and child, and will make living with diapers more convenient, easier and simpler for them when they are “on-the-go”, is a message that resonates in the market segment. Without intending to be bound by theory, and following the discovery thereof, it is believed that visual content realistically depicting one or more apparent real-life situational settings as described herein enable a parent to quickly imagine herself and her child in real-life places or situations in which a diaper change may be necessary but would be more than typically or more than acceptably inconvenient, difficult, disruptive, time-consuming, delaying, unsanitary, embarrassing, indiscrete, interruptive, offensive or inappropriate, and quickly appreciate in a personalized way the advantages of a diaper product having a wearable structure and a replaceable absorbent component. Thus, one or more of the combinations set forth in the appended claims are believed more effective at stimulating interest in the diaper product, and motivating initial purchase, in comparison with other possible approaches.

Without intending to be bound by theory, and following the discovery thereof, it is believed that including visual information that rapidly promotes the consumer's understanding of the general appearance and configuration of the diaper product (not being worn) increases resonance with the market segment and increases the rate of initial purchase intent. Thus, visual information in the form of one or more photographs or substantially accurate artist's illustrations of the diaper product, its wearable structure and replaceable component, and their relative configuration and/or interaction, may be included with other material described herein. Depictions of the two components with indicia showing that they are placed together during use, and/or indicia showing how they fit together (e.g., that the absorbent component slides into the wearable structure at a rearward location thereof), may be particularly effective.

As exemplified by the Figures, the visual content may include a photographic or substantially realistic image of an adult 1 who may appear to be approximately 18 years of age or older, and a photographic or substantially realistic image of a child 2. In one embodiment for what is believed to be one portion of the potential market, the child may appear to be young enough under typical conditions of healthy development (newborn to approximately 3 years of age) to regularly need diapers. In another embodiment for what is believed to be another portion of the potential market including parents or caregivers of children with special needs, the child may appear to be older. Preferably, the adult 1 will appear to be a woman; however, this is not required. Some consumers may be concerned about the location of the replaceable absorbent component relative to the location at which a child urinates (different for boys and girls), and the efficacy of the product in accepting, absorbing and containing the urine. Accordingly, for example, where the replaceable absorbent component fits into the rear of the wearable component of the diaper product as advertised, effectiveness of communication of the product's efficacy may be enhanced if the child 2 depicted appears to be a boy, thus suggesting that the product is effective for boys even though the replaceable absorbent component is located at rear of the wearable component.

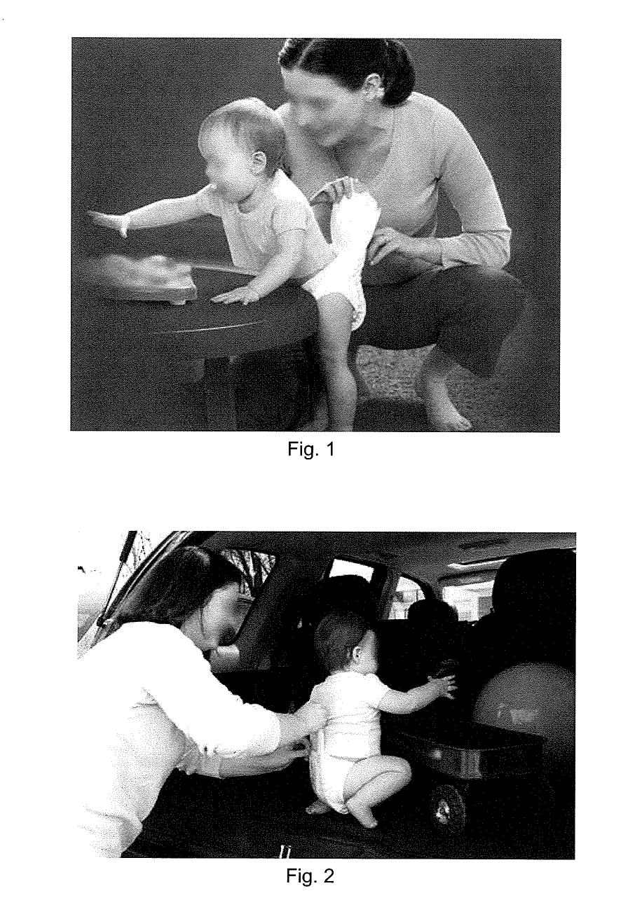

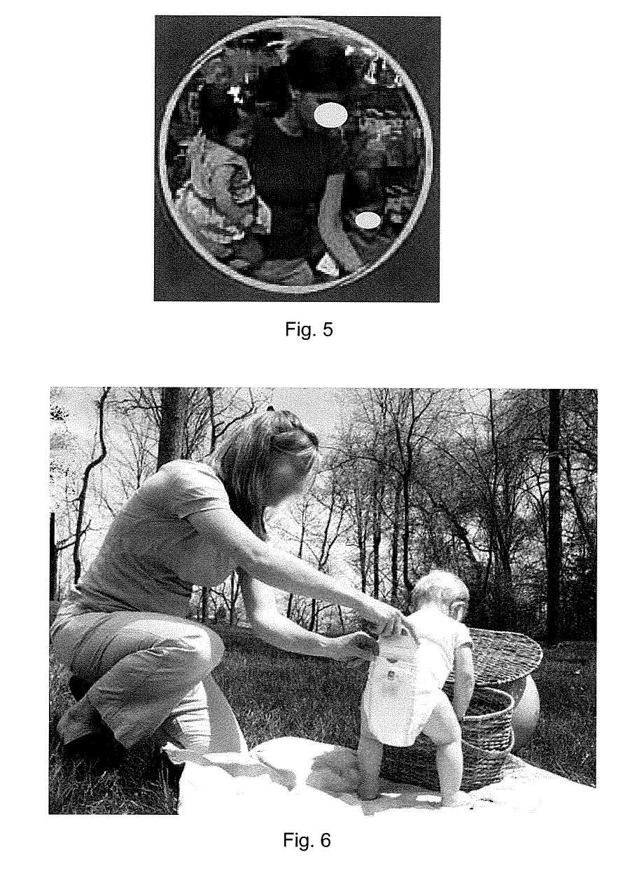

The visual content may include a visual relationship cue which, alone or in the context of its presentation, suggests that the adult and child have a relationship of comfortable familiarity and/or affection, such as parent and child, adult relative and child, adult friend and child, or caregiver and child. The visual relationship cue may be, for example, a depicted gesture of affection such as a kiss or hug. In another example, the adult and child may be depicted in positions in which the absence of such a relationship would make the positions unusual, for example, positions in which the adult is holding or carrying the child with the child's apparent cooperation (e.g., FIG. 5), the adult and child are holding hands, the adult is pushing or moving a stroller or other conveyance or apparatus (e.g., playground equipment) in or on which the child is riding with the child's apparent cooperation, or the adult and child are otherwise in physical contact in a manner that suggests comfortable familiarity, with the child's apparent cooperation. In another example of a visual relationship cue, the adult and child may be depicted engaging in interactive play. The visual relationship cue may also be, for example, a depiction of the adult changing the child's diaper or an absorbent component thereof (e.g., FIGS. 1-4, 6-8C), a depiction of the adult dressing or undressing the child, feeding the child, or otherwise caring for the child or attending to the child's needs (e.g., FIGS. 1-4, 6-8C). In another example, the visual relationship cue may be the absence of any other adults in the same photographic image, together with other context associating the image with the diaper product, thereby suggesting a parent-child relationship. In a further example that includes videographic material, the visual relationship cue may be completed or supplemented with audible cues such as adult talking to child using tones or words suggestive of the relationship.

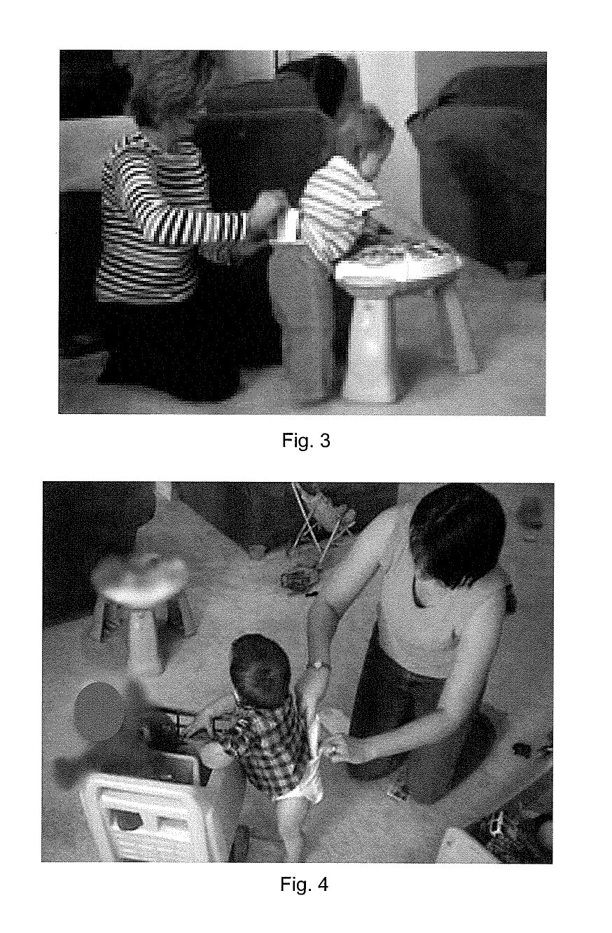

The visual content may include a photographic or substantially realistic image of what appears to be the diaper product or a wearable structure thereof being worn by a child, with the diaper product or wearable structure at least partially in view (e.g., FIGS. 1-4, 6-8C). The child may be completely or only partially in view. The diaper product depicted may appear to include a wearable structure and a removable or replaceable component; they may be depicted together or separated. The diaper product may be depicted completely or mostly exposed (e.g., FIGS. 1, 2), or partially or mostly concealed beneath an outer garment 5 also being worn by the child (e.g., FIG. 3).

The child need not be depicted wearing the diaper product. The image of the child may be accompanied by other context or other content, photographic or otherwise, that depicts the apparent diaper product and associates the visual content depicting the child with the apparent diaper product. For example, the visual content may be displayed in proximity to the diaper product in a store, providing context associating the visual content with the diaper product. In another example, a photographic or substantially realistic image depicting a child may be accompanied by other content in the same tangible medium or videographic medium also apparently depicting the diaper product, either photographically, videographically, or by artist's rendering, and the associative context is provided.

The visual content may include a visual situational cue in the form of one or more images of, at least, an adult and a child, apparently in a situational setting in which a diaper change would be deemed more than typically or more than acceptably inconvenient, difficult, disruptive, delaying, time-consuming, unsanitary, embarrassing, indiscrete, interruptive, offensive or inappropriate. The visual situational cue may be, for example, a depiction of one or both the adult and child engaged in exercise, play or recreation; working at an occupation; performing household chores; attending a school or day-care facility; attending a place of worship; visiting with or entertaining others; attending an entertainment, sporting, cultural or educational event; traveling; sleeping; shopping; attending a social event; dining; or patronizing a place of entertainment, recreation, cultural learning or education. For example, the child may be depicted occupied in solitary play with toys or other objects, or exploration (e.g., FIGS. 1-4, 6-8C), or engaged in play with the adult, or with one or more other adults or children. Adult and/or child may be depicted in what appears to be a yard or garden, a recreational/sports field, an outdoor park, woodland, wilderness or other outdoor surroundings (e.g., FIG. 6). In another example, the adult may be depicted engaged in a sport or in exercise, such as by using a treadmill or other exercise equipment. Adult may be depicted cycling with an attached cart, trailer or other attached conveyance on or in which child is riding; or adult may be depicted jogging and pushing a jogging stroller in which child is riding. In another example, the adult may be depicted apparently present and working at an occupation while still caring for the child. In another example, the adult may be depicted apparently engaged in performing indoor or outdoor household chores or household projects. In another example, the child may be depicted apparently attending a pre-school or day care facility with other children. Adult and child may be depicted inside what is apparently a place of worship, along with other attendees. Adult and child may be depicted apparently attending a social gathering or social occasion with one or more other adults and/or children in a location apparently outside the home. Adult and child may be depicted apparently attending a movie theater, play or sporting event, zoo, museum, concert or amusement park, or dining in a restaurant. Adult and child may be depicted apparently present in or at a retail store or shopping mall (e.g., FIG. 5). Adult and child may be depicted apparently while traveling, such as in an airport, train or bus station, or in or around an automobile, boat, train, bus or airplane (e.g., FIG. 2). In another example, the child may be depicted sleeping. In a further example that includes videographic material, the visual situational cue may be completed or supplemented with audible cues such as adult talking to child or to another person using words suggestive of such situational setting.

Other elements may be included to enhance the efficacy of the visual content.

The adult depicted in the visual content may be selected as having one or more apparent demographic attributes in common with the targeted consumer market segment. For example, and preferably if only a single adult is depicted, the adult representing the parent or caregiver will appear to be a woman, so as to be suggestive of her being the mother of the child depicted. The adult representing the parent or caregiver may be of apparent approximate age falling within a range, for example, 18 to 45, more preferably 25 to 40, still more preferably 25 to 35, and even more preferably 25 to 30, which may be suggestive of age generally typical of parents of very young children.

The adult and/or the child may be depicted with expressions of contentment, smiles or other happy or joyful expressions directed at the other, or elsewhere. If the child is depicted apparently wearing the diaper product, engaged in play or exploration, and while apparently having the replaceable absorbent component changed, the child may be depicted with a smile or other contented, happy or joyful facial expression to enhance the suggestion that the child is content and not being substantially interrupted or distracted from his or her activity. Similarly, if the adult is depicted with a smile or other contented, happy or joyful facial expression, this may enhance the suggestion that the changing experience is quick, simple and/or easy.

The adult may be depicted engaged in replacing a replaceable component of the apparent diaper product while the child is wearing it (e.g., FIGS. 1-4, 6-8C). This may be particularly effective in combination with, or with the backdrop of, a situational setting as described above (e.g., FIGS. 1-4, 6-8C).

Efficacy of the content may be further enhanced if the depicted act of changing the apparent replaceable component is depicted apparently occurring: while the diaper product is at least partially concealed beneath an outer garment 5 the child is wearing, with minimal or no apparent disturbance of the outer garment 5 (e.g., FIG. 3); while the child is standing or partially standing or in an extended posture (e.g., FIGS. 1, 3, 4, 6-8C); and/or while the child is engaged in an activity (e.g., FIGS. 1-4, 6-8C), or is sleeping, with minimal or no apparent substantial interruption to the child's posture or current activity occasioned by the change.

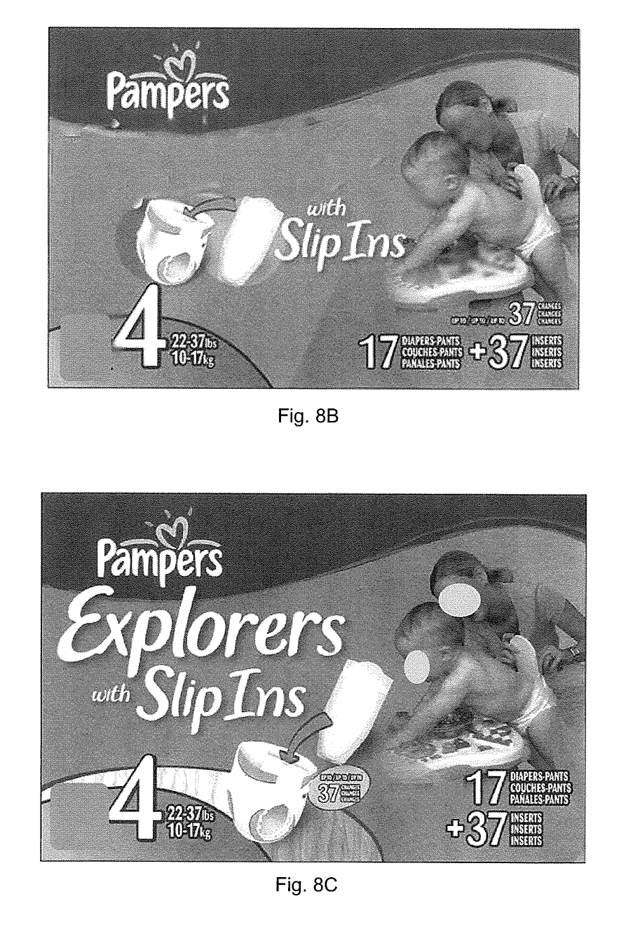

Referring to FIGS. 7-8C, a store display item may also include one or more photographs or artist's renderings depicting the diaper product apart from the child. Such informational illustrations 10 may include a picture of the wearable component 10a and a picture of the replaceable absorbent component 10b. The picture of the wearable component 10a and picture of the replaceable absorbent component 10b may be combined to show the two components together (e.g., FIGS. 7, 8A), or, the picture of the wearable component 10a and the picture of the replaceable absorbent component may be separate (e.g., FIGS. 8B, 8C). Additionally, an indicium such as an arrow 10c may be included and placed among pictures 10a and 10b to show the manner in which the wearable component and the replaceable absorbent component fit or are put together for use (e.g., FIGS. 7, 8A, 8B, 8C). Additionally, the photographic illustration of the adult changing the replaceable absorbent component while the child is wearing the diaper product, described above, may be shot from an angle depicting the change from a direct perspective (e.g., FIGS. 8A-8C), to more clearly illustrate the location where the replaceable absorbent component is placed into the wearable component and/or manner in which the change is effected. In another embodiment, an additional illustration 11 may be included to illustrate this information (e.g., FIGS. 8A).

Another element may include additional visual content depicting changing of a type of diaper other than a diaper product having a wearable structure and a replaceable component (such as a conventional single-piece disposable diaper), for comparative purposes. In one example, a first videographic depiction of a change of an apparent replaceable component, and a second videographic depiction of a change of an apparent conventional single-piece disposable diaper, may be displayed consecutively, or simultaneously in split-screen, side-by-side or other simultaneous format, allowing the viewer to quickly appreciate a comparison of the depicted experiences of both kinds of changes. In a particular example, the change of a replaceable component depicted in the first videographic depiction will be completed substantially more rapidly than the apparent change of a conventional single-piece diaper depicted in the second videographic presentation, and the first videographic depiction may be repeated, simultaneously with the running of the second videographic depiction, as many times as required for the change in the second videographic depiction to be completed. Each repetition of the first videographic depiction may be tallied for the viewer in any suitable fashion, to enable the viewer to better appreciate the rapidity of an apparent change of the replaceable component as compared with an apparent change of a conventional single-piece disposable diaper.

The communicative effect of a videographic presentation may be enhanced if the child is depicted as resistive, struggling, distracted from, interrupted by, disrupted by, or otherwise uncooperative with a depicted diaper change. The communicative effect of a videographic presentation may also be enhanced if apparent distractions for the caregiver are depicted or otherwise represented audibly—such as a ringing telephone or doorbell, an oven timer or boiling pot, a bus preparing to depart from a stop or a final boarding call at an airport, an accident or mishap developing, or other such circumstance that would be expected to draw a caregiver's attention away from the task of a diaper change.

### Methods of Use

The method of the invention involves the use of one or more media including the combinations set forth in the appended claims to convey information to the targeted segment of the consumer market.

A store display having the elements set forth in one or more of the appended claims may be caused to be placed within a retail store in a location proximate to the diaper product, where it is shelved and/or displayed. Since consumers within the target market segment are likely to visit areas of a store proximate to such a location, such placement of a store display will make it viewable by such consumers.

In another example, a tangible medium having the elements set forth in one or more of the appended claims may be caused to be placed in other locations where members of the target market segment can be expected to encounter it. For example, visual content having the elements set forth may be caused to be placed in a print advertisement or flyer in a magazine or newspaper circulated to the public. Preferably, such a magazine or newspaper will be a magazine with household interest, family interest and/or parent interest-oriented theme and content. Current examples include magazines such as AMERICAN BABY, PARENTING, JUNIOR, PARENTS, COOKIE, KIWI, REDBOOK, GOOD HOUSEKEEPING, FAMILY FUN, FAMILY TIMES, TANGO, BABY COUTURE, CHILDREN'S PLAYMATE, PARENTLIFE, PRIMA BABY, CONCEIVE, TODAY'S PARENT, LADIES HOME JOURNAL, BETTER HOMES AND GARDENS, FAMILY CIRCLE, WORKING MOTHER, MORE and MOTHER VERSE.

Visual content having the elements set forth may be caused to be placed on a tangible medium in the form of a sign or display in public view, such as inside a retail store in which the diaper product is available for purchase, or outside and proximate to a retail store in which the diaper product is available for purchase. In another example, a tangible medium in the form of a sign, poster or billboard having the elements set forth may be affixed or placed inside or outside a public bus or train, or along a public sidewalk or public roadway. In another example, visual content having the elements set forth may be transmitted via electronic mail to parents or grandparents of babies and children, or other persons associated with the market segment. In another example, the visual content may be displayed on web sites designed for, or frequented by, parents or grandparents of babies and children, or other persons associated with the market segment. Current examples of such web sites include those having the domain names justmommies.com and babycenter.com. Similarly, one or more of the magazines identified above publish online/web versions, on which the visual content may be displayed.

A videographic medium storing visual content having the elements set forth in one or more of the claims may be caused to be played using suitable equipment and have its visual content made viewable by members of the target consumer market segment. In one example, the visual content may be broadcast and made viewable over a television system. In another example, the visual content may be caused to be played and made viewable within a retail store in which the diaper product is available, preferably at a location proximate to the location in which the diaper product is shelved or displayed. In a further example, the videographic medium may be a digital storage medium within a server, accessible for playback of the visual content when an Internet user accesses a web site that may be owned, operated, shared, used or accessed by a producer or seller of the product.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for communicating the relevance and benefits of a diaper product to members of a market segment, comprising:
providing a tangible medium containing visual content, comprising:
a first photographic image depicting an adult;
the first photographic image also depicting, or a second photographic image depicting, a child;
at least one of the first photographic image or the second photographic image depicting, or a third photographic image depicting, the child wearing an apparent diaper product, with the apparent diaper product in at least partial view, and the adult appearing to be engaged in the act of changing an apparent replaceable component of the apparent diaper product while the child is wearing the apparent diaper product; and
causing the visual content to be made available for viewing by members of the public.

2. The method of claim 1 wherein at least one of the first photographic image, the second photographic image or the third photographic image contains a visual situational cue suggesting that one or both of the depicted adult and child are in a situational setting in which a diaper change would be inconvenient, difficult, disruptive, delaying, time-consuming, unsanitary, embarrassing, indiscrete, interruptive, offensive or inappropriate.

3. The method of claim 2 wherein the visual situational cue comprises a depiction of one or both of the adult and child appearing to be engaged in an activity selected from the group consisting of exercise, play or recreation; working at an occupation; performing household chores; attending a school or day-care facility; attending a place of worship; visiting with or entertaining others; attending an entertainment, sporting, cultural or educational event; traveling; sleeping; shopping; attending a social event; dining; or patronizing a place of entertainment, recreation, cultural learning or education.

4. The method of claim 1 wherein at least one of the first, second or third photographic images contains a visual relationship cue suggesting that the depicted adult and child have a relationship of comfortable familiarity and/or affection.

5. The method of claim 4 wherein the visual relationship cue comprises a depiction of the adult or child appearing to be engaged in an action selected from the group consisting of a kiss or hug of the other; the adult holding or carrying the child with the child's apparent cooperation; holding hands; the adult moving a stroller or other conveyance in which the child is riding with apparent cooperation; riding together in a car, bus, train, boat or airplane; engaging in physical contact with the child's apparent cooperation; interactive play; the adult observing the child while the child is playing, sleeping, or engaged in another activity; the adult dressing or undressing the child with the child's apparent cooperation; the adult changing the child's diaper or an absorbent component thereof; or the adult feeding or caring for the child or attending to the child's needs.

6. The method of claim 1 wherein the depicted apparent act of changing the apparent replaceable component appears to be taking place while the child is wearing a garment over the apparent diaper product.

7. The method of claim 1 wherein the depicted apparent act of changing the apparent replaceable component appears to be taking place while the child is substantially in a standing position or extended posture.

8. The method of claim 1 wherein during the depicted apparent act of changing the apparent replaceable component, the child appears to be engaged in play or exploration, and the apparent act of changing appears not to be substantially interrupting the child's play or exploration, or distracting the child.

9. The method of claim 1 wherein at least one of the first, second or third photographic images is present on packaging of the diaper product.

10. The method of claim 1 wherein the adult appears to be a woman.

11. The method of claim 1 wherein the adult appears to be of an age approximately within the range of 18 to 45 years.

12. A method for communicating the relevance and benefits of a diaper product to members of a market segment, comprising:
providing a store display containing visual content, comprising:
a first photographic image depicting an adult;
the first photographic image also depicting, or a second photographic image depicting, a child;
at least one of the first photographic image or the second photographic image depicting, or a third photographic image depicting, the child wearing an apparent diaper product, with the apparent diaper product in at least partial view, and the adult appearing to be engaged in the act of changing an apparent replaceable component of the apparent diaper product while the child is wearing the apparent diaper product; and
causing the store display to be placed in a retail store in a location proximate to a place where the diaper product is shelved or displayed,
wherein the diaper product comprises in combination a wearable structure and a replaceable absorbent component, the wearable structure and the replaceable absorbent component being packaged and shelved together or separately.

13. A method for communicating the relevance and benefits of a diaper product to members of a market segment, comprising:
providing a tangible medium containing visual content, comprising:
a first photographic image depicting an adult;
the first photographic image also depicting, or a second photographic image depicting, a child;
the first photographic image, or the second photographic image, or a third image depicting an apparent diaper product in at least partial view, wherein the apparent diaper product further appears to include a wearable structure and a removable or replaceable component;
at least one of the first or second photographic images containing, or a fourth photographic image containing, a visual situational cue suggesting that one or both of the adult and child are in a situational setting in which a diaper change would be inconvenient, difficult, disruptive, delaying, time-consuming, unsanitary, embarrassing, indiscrete, interruptive, offensive or inappropriate; and
causing the visual content to be made available for viewing by members of the public.
